(19) United States
(12) Patent Application Publication
(10) Pub. No.: US 2025/0079591 A1
(43) Pub. Date: Mar. 6, 2025

(54) BATTERY MODULE

(71) Applicant: Caterpillar Inc., Peoria, IL (US)

(72) Inventors: Alexander C. Crosman, III, Dunlap, IL (US); Dustin Irvin Landwehr, Kewanee, IL (US)

(73) Assignee: Caterpillar Inc., Peoria, IL (US)

(21) Appl. No.: 18/458,308

(22) Filed: Aug. 30, 2023

(51) Int. Cl. H01M 50/204; H01M 50/258; H01M 50/262; H01M 50/271

(52) U.S. Cl. CPC H01M 50/204; H01M 50/258; H01M 50/262; H01M 50/271

(57) ABSTRACT

A battery module includes a housing. The housing includes a first end plate and a second end plate. The housing further includes a first side plate coupled to the first end plate and the second end plate. The housing includes a second side plate opposite the first side plate. The housing also includes a cover extending between the first end plate and the second end plate. The housing further includes a plurality of projections extending from the base surface of the cover. The plurality of projections are arranged to define a recess. The battery module also includes a plurality of battery cells secured within the housing between the first end plate, the second end plate, the first side plate, and the second side plate.

### TECHNICAL FIELD

The present disclosure relates to a battery module and a battery system having the battery module.

### BACKGROUND

Battery modules are used in a variety of applications as a means of power supply. For example, battery modules are being increasingly implemented in passenger vehicles, construction machines, and the like to provide power supply. Generally, the battery module includes one or more battery cells. In order to perform efficiently, heat is required to keep the battery module warm enough to provide constant power supply. If the battery module is cold, it may not provide the desired power supply and may cause damage to the battery cells.

Typically, one or more heater pads are disposed within a housing of the battery module during manufacturing of the battery module. The heater pad is integral with the battery module. However, such heater pads may not be required in all applications. For example, heater pads may not be required when the battery module is being used in warm environments. Due to the current design and techniques of disposing the heater pads, every battery module may have to bear the added costs and complexity of the heater pad even when the heater pad is not required for a particular application. In some applications, when heater pads are not required, battery modules may be manufactured without the integral heater pads. However, such an approach may increase part numbers associated with the battery module.

U.S. Publication Application Number 2022/0393262 describes a battery module including a housing, assembled from a first side wall, a second side wall, a first end plate, and a second end plate, is configured to support a plurality of battery cells. The battery module also includes a heating pad and a cooling plate that are configured to regulate a thermal state of the plurality of battery cell. The heating pad is disposed substantially adjacent to the plurality of battery cells and the cooling plate is disposed adjacent to the heating pad opposite the plurality of battery cells. A controller associated with the battery module is configured to receive an indication of battery temperature and active one of the heating pad or the cooling plate based at least on the battery temperature of the plurality of battery cells.

### SUMMARY OF THE DISCLOSURE

In an aspect of the present disclosure, a battery module is provided. The battery module includes a housing. The housing includes a first end plate defining a first end of the battery module. The housing also includes a second end plate defining a second end of the battery module opposite the first end. The housing further includes a first side plate coupled to the first end plate and the second end plate at a third end of the battery module. The housing includes a second side plate opposite the first side plate at a fourth end of the battery module. The second side plate is coupled to the first end plate and the second end plate. The housing also includes a cover extending between the first end plate and the second end plate. The cover defines a base surface. The housing further includes a plurality of projections extending from the base surface of the cover. The plurality of projections are arranged to define a recess. The battery module also includes a plurality of battery cells secured within the housing between the first end plate, the second end plate, the first side plate, and the second side plate. The cover surrounds the plurality of battery cells.

In another aspect of the present disclosure, a battery system is provided. The battery system includes at least one battery cell stack including a plurality of battery modules. The plurality of battery modules are stacked along a vertical axis of the battery system. Each battery module includes a housing. The housing includes a first end plate defining a first end of the battery module. The housing also includes a second end plate defining a second end of the battery module opposite the first end. The housing further includes a first side plate coupled to the first end plate and the second end plate at a third end of the battery module. The housing includes a second side plate opposite the first side plate at a fourth end of the battery module. The second side plate is coupled to the first end plate and the second end plate. The housing also includes a cover extending between the first end plate and the second end plate. The cover defines a base surface. The housing further includes a plurality of projections extending from the base surface of the cover. The plurality of projections are arranged to define a recess. The battery module also includes a plurality of battery cells secured within the housing between the first end plate, the second end plate, the first side plate, and the second side plate. The cover surrounds the plurality of battery cells.

Other features and aspects of this disclosure will be apparent from the following description and the accompanying drawings.

### BRIEF DESCRIPTION OF THE DRAWINGS

FIG. 1 is a schematic perspective view of an exemplary battery system, according to an example of the present disclosure;

FIG. 2 is a schematic perspective view of a battery module, according to an example of the present disclosure;

FIG. 3 is a schematic bottom view of the battery module of FIG. 2;

FIG. 4 is a schematic perspective view of an exemplary heating device associated with the battery module of FIG. 2;

FIG. 5 is a schematic exploded view of a portion of the battery system of FIG. 1; and

FIG. 6 is a schematic exploded view of a portion of the battery system of FIG. 1 illustrating a pair of end battery modules.

### DETAILED DESCRIPTION

Wherever possible, the same reference numbers will be used throughout the drawings to refer to the same or like parts.

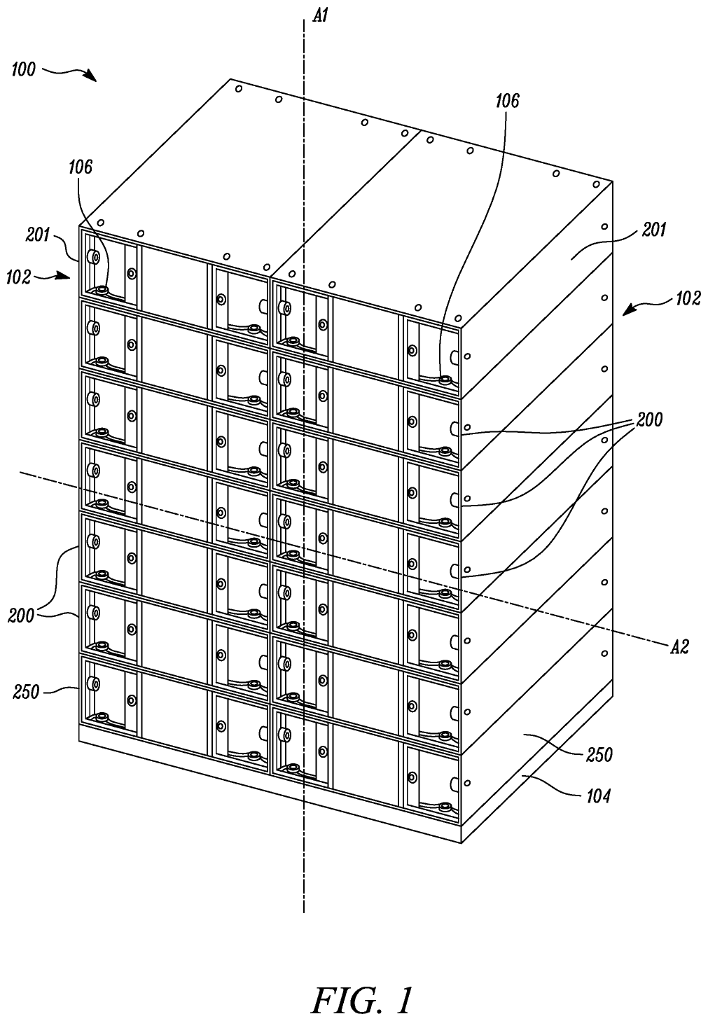

Referring to FIG. 1, a schematic perspective view of an exemplary battery system 100 is illustrated. In an example, the battery system 100 may supply electrical power to a machine. The machine may include a moving machine or a stationary machine. In some examples, the machine may be a work/construction machine, for example.

The battery system 100 includes one or more battery cell stacks 102. The one or more battery cell stacks 102 include a number of battery modules 200, 201, 250. The number of battery modules 200, 201, 250 are stacked along a vertical axis Al of the battery system 100. The number of battery modules 200, 201, 250 are electrically coupled together in a stacked relationship to provide a desired amount of power output and voltage output. In the illustrated example of FIG. 1, the battery system 100 includes a pair of battery stacks 102 disposed adjacent to each other along a horizontal axis A2 perpendicular to the vertical axis A1. However, the battery system 100 may include any number of adjacently disposed battery stacks 102, based on application requirements. Further, each battery module 200, 201, 250 may be mechanically coupled to a vertically adjacent battery module 200, 201, 250 using fasteners 106. The fasteners 106 may include bolts, screws, pins, and the like.

The battery modules 201 are mounted at a top end of the battery stack 102. Further, the number of battery modules 200, 201, 250 include an end battery module 250. As the battery system 100 includes two battery stacks 102 herein, the battery system 100 includes two end battery modules 250. The end battery modules 250 are disposed at a bottom end of the battery stack 102, opposite the battery modules 201. The battery modules 250 are hereinafter interchangeably referred to as end battery modules 250. Further, the battery modules 200 are mounted between the battery modules 201 and the end battery modules 250. It should be noted that the battery modules 200, 201, 250 may be substantially similar to each other in design and dimensions.

The battery system 100 also includes a base structure 104. The one or more battery cell stacks 102 are mounted on the base structure 104. In some examples, the base structure 104 may be made of aluminum, composites, plastics, and/or any other suitable material. The end battery modules 250 are directly coupled to the base structure 104.

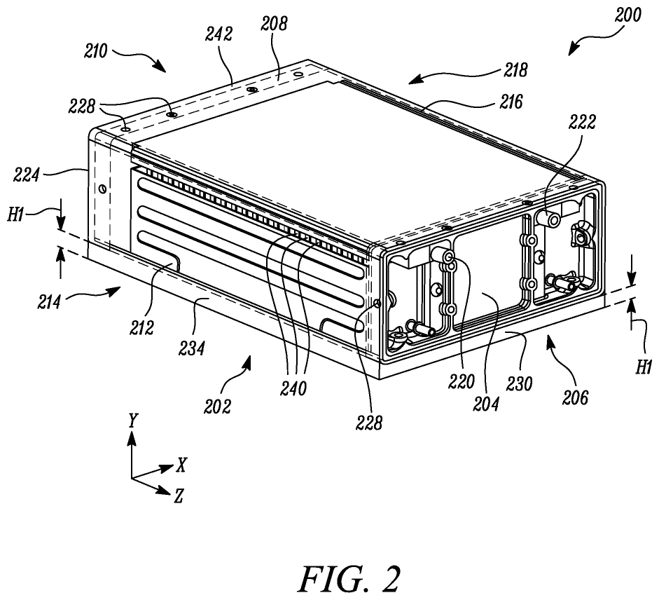

FIG. 2 is a schematic perspective view of the battery module 200, according to an example of the present disclosure. Although only the single battery module 200 is being explained in detail, the details provided herein are equally applicable to the battery modules 201, 250 with common components being referred to by the same numerals. The battery module 200 includes a housing 202. In some examples, the battery module 200, or components thereof, such as the housing 202, may be made of aluminum, composites, plastics, and/or any other suitable material. In the illustrated example of FIG. 2, the housing 202 is rectangular in shape. In other examples, the housing 202 may have a square shape.

The housing 202 includes a first end plate 204 defining a first end 206 of the battery module 200. The first end plate 204 extends along an X-direction. The first end plate 204 includes a positive terminal 220 and a negative terminal 222.

The housing 202 also includes a second end plate 208. The second end plate 208 defines a second end 210 of the battery module 200 opposite the first end 206. The second end plate 208 extends along the X-direction. The second end plate 208 is spaced apart from the first end plate 204 in a Z-direction.

The housing 202 further includes a first side plate 212 coupled to the first end plate 204 and the second end plate 208 at a third end 214 of the battery module 200. The housing 202 includes a second side plate 216 opposite the first side plate 212 at a fourth end 218 of the battery module 200. The second side plate 216 is coupled to the first end plate 204 and the second end plate 208. In other words, the first end plate 204, the second end plate 208, the first side plate 212, and the second side plate 216 together form the housing 202 and thereby form a sealed structure.

The first side plate 212 and the second side plate 216 extend along the Z-direction and are parallel to each other to define the respective ends 214, 218 of the housing 202. It should be noted that the first side plate 212 and the second side plate 216 are connected to the first end plate 204 and the second end plate 208, for example, by welding.

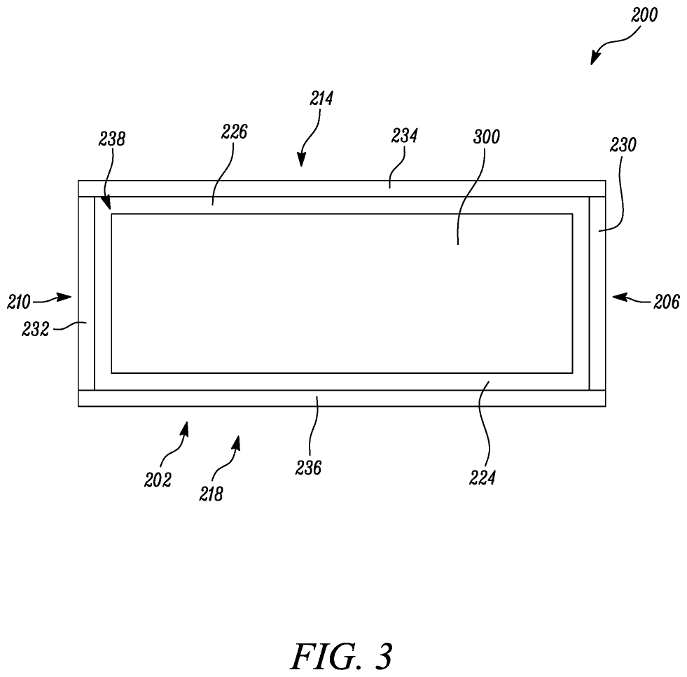

The housing 202 also includes a cover 224 extending between the first end plate 204 and the second end plate 208. The cover 224 surrounds the first side plate 212 and the second side plate 216 of the housing 202. The cover 224 is coupled to the first end plate 204 and the second end plate 208 via one or more fastening means 228. In some examples, the fastening means 228 may include a bolt, a screw, a pin, a rivet, or any other fastening means. The first end plate 204, the second end plate 208, and the cover 224 are coupled to each other and define an interior cavity of the battery module 200. In some cases, the cover 224 forms a substantially fluid-tight seal with the first end plate 204 and the second end plate 208. The cover 224 defines a base surface 226 (shown in FIG. 3). The cover 224 further defines a top surface 242 opposite the base surface 226.

The battery module 200 further includes one or more battery cells 240 secured within the housing 202 between the first end plate 204, the second end plate 208, the first side plate 212, and the second side plate 216. The cover 224 surrounds the one or more battery cells 240. The first side plate 212 and the second side plate 216 along with the first end plate 204 and the second end plate 208 retain the battery cells 240 within the battery module 200 to prevent movement, shifting, and the like during use. It should be noted that the battery cells 240 are disposed within the interior cavity of the battery module 200 defined by the first end plate 204, the second end plate 208, and the cover 224.

The one or more battery cells 240 may incorporate, for example, a lithium-ion battery technology to store electrical power and distribute the stored electrical power at a battery module voltage and a battery module amperage. It should be noted that the power distribution and power storage characteristics of the battery module 200 may be defined at least in part on the configurations of the one or more battery cells 240 included in the battery module 200. In other examples, the battery module 200 may embody any other type of battery technology, such as, a lead-acid battery technology, nickel metal hydride battery technology, and the like that converts chemical energy directly to electrical energy by utilizing a difference in bond energies of the compounds utilized in the construction of the battery module 200. Further, the battery cells 240 may include any capacity, voltage, energy, etc.

The battery module 200 further includes a number of projections 230, 232, 234, 236 (see FIG. 3) extending from the base surface 226 of the cover 224. In some examples, the projections 230, 232, 234, 236 may be integral with the cover 224. Alternatively, the projections 230, 232, 234, 236 may be coupled to the cover 224 using techniques, such as, welding, soldering, brazing, and the like, or using mechanical fasteners, such as, bolts, pins, screws, and the like.

Further, the number of projections 230, 232, 234, 236 include four projections (only two of which are visible in FIG. 2) herein. The projections 230, 232, 234, 236 are embodied as rectangular bar members herein. Referring now to FIG. 3, the projections 230, 232, 234, 236 include a first projection 230 extending from the cover 224 proximate to the first end 206 of the battery module 200, a second projection 232 extending from the cover 224 proximate to the second end 210 of the battery module 200, a third projection 234 extending from the cover 224 proximate to the third end 214 of the battery module 200, and a fourth projection 236 extending from the cover 224 proximate to the fourth end 218 of the battery module 200. In some cases, the first projection 230, the second projection 232, the third projection 234, and the fourth projection 236 may extend along the edges of the cover 224. It should be noted that the battery module 200 may include any number of projections, for example, two projections that may be parallel to each other, based on application attributes.

The projections 230, 232, 234, 236 are arranged to define a recess 238. Specifically, each projection 230, 232, 234, 236 extends orthogonally relative to an adjacent projection 230, 232, 234, 236 to define the recess 238. In some examples, the projections 230, 232, 234, 236 may be arranged to form a square-shaped recess or a rectangular-shaped recess. In the illustrated example of FIG. 3. the projections 230, 232, 234, 236 are arranged to form the recess 238 that is rectangular in shape. Further, each projection 230, 232, 234, 236 define a height H1 (shown in FIG. 2).

The battery module 200 further includes a heating device 300. The heating device 300 is disposed external to the housing 202 and removably coupled to the base surface 226 of the housing 202. As shown in FIG. 3, the heating device 300 is received within the recess 238 defined by the projections 230, 232, 234, 236.

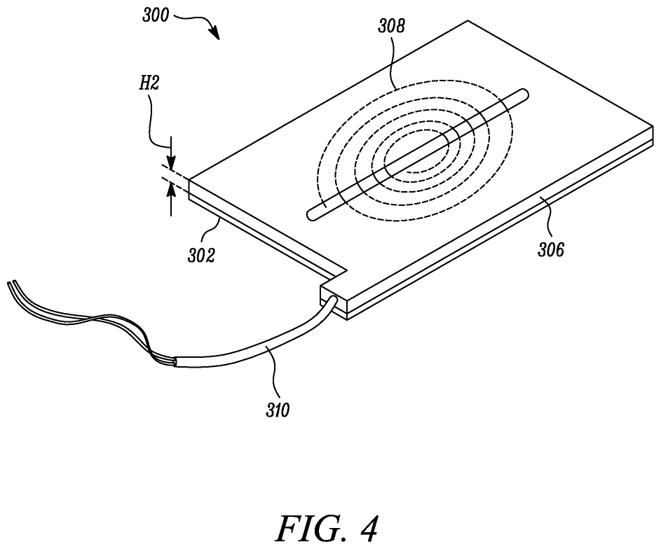

FIG. 4 is a schematic perspective view of the heating device 300, according to an example of the present disclosure. The heating device 300 defines a height H2. It should be noted that the height H1 (see FIG. 2) of each of the projections 230, 232, 234, 236 (see FIGS. 2 and 3) is greater than the height H2 of the heating device 300. Thus, the heating device 300 may accommodate within the recess 238 defined by the first projection 230, the second projection 232, the third projection 234, and the fourth projection 236.

The heating device 300 includes an outer cover 306 and a resistive heating element 308 disposed within the outer cover 306. In some examples, the resistive heating element 308 may be a heating wire, a heating coil, a heating ribbon, a heating strip, and the like. In the illustrated example of FIG. 4, the resistive heating element 308 includes the resistive coil. Further, the outer cover 306 is made of a flexible material. In some examples the outer cover 306 may be made of silicone. The outer cover 306 may be moisture resistant and chemical resistant.

The heating device 300 further includes electric leads 310 that project out from the outer cover 306. It should be noted that the heating device 300 described herein is exemplary in nature, and the heating device 300 may include any other design or configuration, as per application requirements.

The battery module 200 includes a connecting element 302 removably coupling the heating device 300 with the base surface 226 (see FIG. 3) of the housing 202 (see FIG. 3). In the illustrated example of FIG. 4, the connecting element 302 includes an adhesive layer disposed between the heating device 300 and the base surface 226 of the housing 202. The adhesive layer may include, for example, a double-sided tape. Further, a release liner may be coupled to the adhesive layer. When the heating device 300 is to be coupled with the base surface 226, the release liner may be removed thereby exposing adhesive of the adhesive layer that may allow coupling of the heating device 300 with the base surface 226. In some examples, the adhesive layer may form a part of the heating device 300 itself. In other examples, the adhesive layer may be separate from the heating device 300 and may be coupled to each of the heating device 300 and the base surface 226 during the coupling of the heating device 300 with the base surface 226. In other examples, the connecting element 302 may include any other type of fastening means instead of the adhesive layer that may allow coupling of the heating device 300 with the base surface 226 of the housing 202.

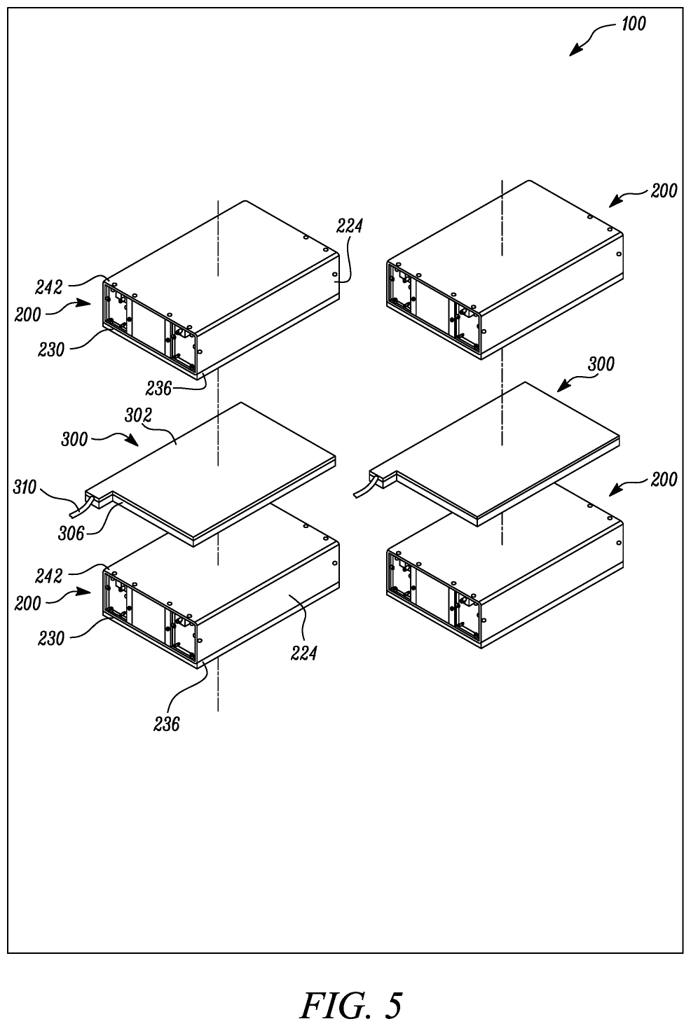

FIG. 5 is a schematic exploded view of a portion of the battery system 100 of FIG. 1. When the battery modules 200 are in a stacked configuration, the heating device 300 of one battery module 200 is disposed between the base surface 226 (see FIG. 3) of the one battery module 200 and the top surface 242 of the battery module 200 that is vertically disposed below the one battery module 200. Thus, one heating device 300 is disposed between two vertically adjacent battery modules 200.

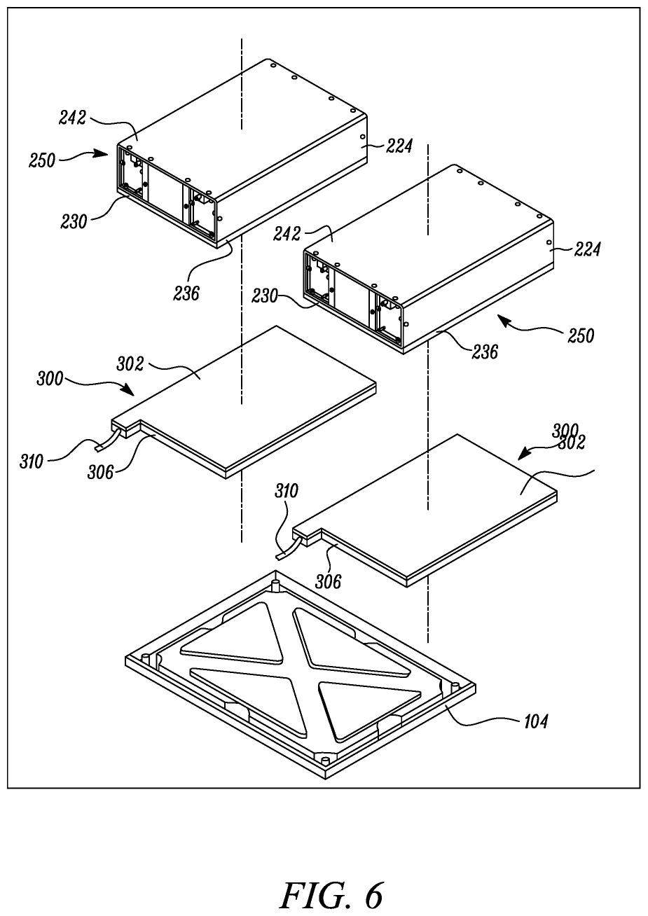

FIG. 6 is a schematic exploded view of a portion of the battery system 100 of FIG. 1. As shown in FIG. 6, the heating device 300 associated with the end battery module 250 is disposed between the base surface 226 (as shown in FIG. 3) of the end battery module 250 and the base structure 104.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the battery module 200, 201, 250 that allows the heating device 300 to be installed external to the battery module 200, 201, 250. In other words, the battery module 200, 201, 250 includes the projections 230, 232, 234, 236 that together define the recess 238. The heating device 300 may be removably received within the recess 238. Further, the projections 230, 232, 234, 236 enclose the heating device 300 on all sides and may protect the heating device 300 from any damage. Furthermore, the height H1 of the projections 230, 232, 234, 236 is greater than the height H2 of the heating device 300, hence, a gap may be observed between the heating device 300 and a vertically adjacent battery module 200, 201, 250. Thus, when the battery modules 200, 201, 250 are stacked together, a possibility of forces/damage to the heating device 300 due to a weight of the battery modules 200, 201, 250 may be reduced.

Further, as the heating device 300 is disposed external to the battery module 200, 201, 250, the heating device 300 may be installed based on application requirements. For example, if the battery system 100 is installed in machines used in colder environments, the user may be able to quickly couple the heating device 300 with the battery module 200, 201, 250 without dismantling the battery module 200, 201, 250. Thus, the heating device 300 may form an additional accessory associated with the battery module 200, 201, 250, rather than being an integral part of the battery module 200, 201, 250. Further, the heating device 300 may be eliminated from machines that are used in warm environments. Thus, the design of the battery module 200, 201, 250 described herein may allow the battery module 200, 201, 250 to be used across multiple applications without burdening machines used in warm environments with cost and complexity of the heating device 300.

Furthermore, the connecting element 302 includes the adhesive layer that removably couples the heating device 300 with the base surface 226 of the housing 202. Overall, the connecting element 302 may allow easy and quick coupling of the heating device 300 with the battery module 200, 201, 250, without requiring any additional tools or set-ups.

The battery module 200, 201, 250 described herein may also reduce part numbers as a single battery module design may be used for different machines that operate in cold environments or warm environments. Further, the battery system 100 having the battery module 200, 201, 250 may be retrofitted on existing machines.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery module, comprising:
a housing including:
a first end plate defining a first end of the battery module;
a second end plate defining a second end of the battery module opposite the first end;
a first side plate coupled to the first end plate and the second end plate at a third end of the battery module; and
a second side plate opposite the first side plate at a fourth end of the battery module, the second side plate being coupled to the first end plate and the second end plate;
a cover extending between the first end plate and the second end plate, the cover defining a base surface; and
a plurality of projections extending from the base surface of the cover, wherein the plurality of projections are arranged to define a recess; and
a plurality of battery cells secured within the housing between the first end plate, the second end plate, the first side plate, and the second side plate, wherein the cover surrounds the plurality of battery cells.

2. The battery module of claim 1, further comprising a heating device disposed external to the housing and removably coupled to the base surface of the housing, wherein the heating device is received within the recess defined by the plurality of projections.

3. The battery module of claim 2, further comprising a connecting element removably coupling the heating device with the base surface of the housing.

4. The battery module of claim 3, wherein the connecting element includes an adhesive layer disposed between the heating device and the base surface of the housing.

5. The battery module of claim 2, wherein the heating device includes an outer cover and a resistive heating element disposed within the outer cover, and wherein the outer cover is made of a flexible material.

6. The battery module of claim 2, wherein a height of the each of the plurality of projections is greater than a height of the heating device.

7. The battery module of claim 1, wherein the plurality of projections include four projections, and wherein each projection extends orthogonally relative to an adjacent projection to define the recess.

8. The battery module of claim 1, wherein the plurality of projections include a first projection extending from the cover proximate to the first end of the battery module, a second projection extending from the cover proximate to the second end of the battery module, a third projection extending from the cover proximate to the third end of the battery module, and a fourth projection extending from the cover proximate to the fourth end of the battery module.

9. The battery module of claim 1, wherein the plurality of projections are arranged to form at least one of a square-shaped recess and a rectangular-shaped recess.

10. A battery system, comprising:
at least one battery cell stack including a plurality of battery modules, wherein the plurality of battery modules are stacked along a vertical axis of the battery system, and wherein each battery module includes:
a housing including:
a first end plate defining a first end of the battery module;
a second end plate defining a second end of the battery module opposite the first end;
a first side plate coupled to the first end plate and the second end plate at a third end of the battery module; and
a second side plate opposite the first side plate at a fourth end of the battery module, the second side plate being coupled to the first end plate and the second end plate;
a cover extending between the first end plate and the second end plate, the cover defining a base surface; and
a plurality of projections extending from the base surface of the cover, wherein the plurality of projections are arranged to define a recess; and
a plurality of battery cells secured within the housing between the first end plate, the second end plate, the first side plate, and the second side plate, wherein the cover surrounds the plurality of battery cells.

11. The battery system of claim 10, further comprising a heating device disposed external to the housing and removably coupled to the base surface of the housing, wherein the heating device is received within the recess defined by the plurality of projections.

12. The battery system of claim 11, further comprising a connecting element removably coupling the heating device with the base surface of the housing.

13. The battery system of claim 12, wherein the connecting element includes an adhesive layer disposed between the heating device and the base surface of the housing.

14. The battery system of claim 11, wherein the heating device includes an outer cover and a resistive heating element disposed within the outer cover, and wherein the outer cover is made of a flexible material.

15. The battery system of claim 11, wherein the cover further defines a top surface opposite the base surface, and wherein, when the battery modules are in a stacked configuration, the heating device of at least one battery module is disposed between the base surface of the at least one battery module and the top surface of the battery module that is vertically disposed below the at least one battery module.

16. The battery system of claim 11, further comprising a base structure, wherein the at least one battery cell stack is mounted on the base structure, wherein the plurality of battery modules include an end battery module.

17. The battery system of claim 17, further wherein the heating device of the end battery module is disposed between the base surface of the end battery module and the base structure.

18. The battery system of claim 10, wherein the plurality of projections include four projections, and wherein each projection extends orthogonally relative to an adjacent projection to define the recess.

19. The battery system of claim 10, wherein the plurality of projections include a first projection extending from the cover proximate to the first end of the battery module, a second projection extending from the cover proximate to the second end of the battery module, a third projection extending from the cover proximate to the third end of the battery module, and a fourth projection extending from the cover proximate to the fourth end of the battery module.

20. The battery system of claim 10. wherein the plurality of projections are arranged to form at least one of a square-shaped recess and a rectangular-shaped recess.
